(19) United States
(12) Patent Application Publication
(10) Pub. No.: US 2003/0055160 A1
(43) Pub. Date: Mar. 20, 2003

(54) Polyamide resin composition for fuse elements, and fuse element

(76) Inventors: Masaaki Yamazaki, Uji-shi (JP); Koji Fujimoto, Uji-shi (JP); Iwao Murakami, Ogaki-shi (JP); Hideki Andoh, Ogaki-shi (JP)

Correspondence Address: BIRCH STEWART KOLASCH & BIRCH, PO BOX 747, FALLS CHURCH, VA, 22040-0747, US

(21) Appl. No.: 10/213,101

(22) Filed: Aug. 7, 2002

(30) Foreign Application Priority Data
Aug. 7, 2001 (JP) 2001-239217

(51) Int. Cl. C08L 79/00

(52) U.S. Cl. 524/606

(57) ABSTRACT

The present invention is to provide a polyamide resin composition for fuse elements, assuring sufficient arc resistance upon boosting of vehicles voltage (e.g., 42 V system), being excellent in rigidity, heat resistance and transparency.

The present invention relates to a polyamide resin composition for fuse elements, comprising: a mixed polyamide 100 parts by mass consisting of (A) polycaproamide (nylon 6) 95 to 5% by mass and (B) poly(hexamethylene adipamide) (nylon 66) 5 to 95% by mass; and (C) a silicate layer of lamellar silicate 0.1 to 20 parts by mass dispersed on molecular order level in the above described (A) and/or (B). The polyamide resin composition may further contain (D) an antioxidant, (E) a metal soap based lubricant, and/or (F) an inorganic fibrous reinforcing material are contained. The present invention also relates to a fuse element formed from the polyamide resin composition for fuse elements.

### TECHNICAL FIELD

The present invention relates to a polyamide resin composition which is excellent in arc resistance, transparency, heat resistance and productivity and which is, for example, suitably usable for a fuse element for electric circuit for cars etc., and a fuse element formed of the composition.

### BACKGROUND ART

Wiring of various electrical components in an automobile is generally assembled in a fuse box, and the various electrical components are connected to a battery through fuse elements having a rated current value according to magnitude of electric current flowing thereto and operating frequency, etc. Such a fuse element 1 (FIG. 1) is provided with a housing 2 and a pair of terminals 3, 4 projecting from a predetermined flat surface thereof and arranging in parallel to each other, and has a structure where a fusing-element 5 connected between both terminals is housed in the housing 2. When unusual electric current equal to or more than a rating is generated due to some factors, conduction between an input terminal and an output terminal is turned off by melting fusing-element 5 of this fuse element, and it is prevented that overcurrent continues to flow to various electrical components. Conventionally, transparent resins such as polysulfones and polyethersulfones which are excellent in heat resistance and insulation are used for the housing 2 of the fuse element 1, and it is constituted so that it may be easily determined from outside whether the fusing-element is melted.

A number of battery systems having 14 V power generation (12 V power accumulation) are conventionally mounted in automobiles, and the above described fuse element has been designed having a rated voltage 32 V and a interception property 32 V×1000 A (rated voltage×rated interception capacity) in order to correspond to the battery system. However, increase in electricity consumption is enhanced in recent years in whole vehicles, in accordance with increases in mounting of electrical components and electronic control devices, and expansion of size thereof. Thereby, it poses problems that vehicles weight is increased due to enlargement of battery or alternator and of thickening of wire harness etc., and boosting of vehicles voltage (42 V system) is now examined as a radical solution.

If boosting of the vehicles voltage is performed into a 42 V system, at the time of melting of a fusing-element installed in a fuse element, an arc having a larger voltage value than voltage value at the time of the fuse element melting in the conventional 14 V system will be generated for a long time. However, arc resistance of polysulfone and polyethersulfone etc. constituting a conventional housing is not so high as it can respond to the 42 V system. This is caused by carbonization of polymer having aromatic ring in principal chain, and is essential phenomenon resulting from the resin itself. That is, although the fusing-element was melted, leakage current flowed housing inside, a conductive state between both of terminals is maintained, and there is a possibility that the housing and the terminal might be melt and broken. Therefore, development of a fuse element formed of a resin having a structure not making housing inside carbonized at the time of melting and breaking of fusing-element even in the 42 V system has been required.

From the above circumstances, in order to maintain (a) arc resistance required as a fuse element housing, a fuse element housing of aliphatic polyamide resins is now examined. However, further problems (b) to (e) have arisen by the selection of aliphatic polyamide resins as a priority item for arc resistance. That is: (b) deformation at the time of fuse melting; (c) transparency for fuse visual check; (d) abrasion of a mold at the time of molding; and (e) heat discoloration in use.

It is preferable to use nylon 66 resin having high heat deformation temperature in aliphatic polyamides in order to prevent (b) deformation at the time of fuse melting. However, this resin has a high crystallinity and when it is used singly, (c) transparency is lost to disable visual check of fusing-element in a housing. This problem is solved by mixing nylon 6 that is a same aliphatic polyamide resin to the nylon 66 and by reducing the crystallinity of a whole mixed resin, since nylon 6 has heat deformation temperature lower than the nylon 66. It is, however, necessary that heat deformation temperature that is decreased with mixing of nylon 6 should be compensated by addition of a little amount of fibrous reinforcing material (generally, a glass fiber is used). In this way, the combination of nylon 66+nylon 6+glass fiber has been examined as a resin composition satisfying (b) and (c) However, this combination of glass fiber as inorganic reinforcing material causes promotion of abrasion of mold at the time of injection molding to give frequent exchange of mold, and there is a problem (d) of reduced productivity.

Identification by classification based on color is given to fuse elements, for every magnitude of rated current in consideration of safety or convenience at the time of exchange. Therefore, (e) discoloration by heat in an engine room is preferably inhibited in materials for fuse element housings.

### DISCLOSURE OF THE INVENTION

(Technical Problems to be Solved by the Invention)

An object of the present invention is to provide a resin composition which suppresses generation of a leakage current caused by carbonization inside a housing at the time of blowing of a fusing-element in a fuse element mounted in a battery system with boosted voltage, and which has heat-resistant deformation property, transparency and low mold abrasion property suitable for the fuse element, and further has heat-resistant discoloration property.

(Method for Solving the Same)

As a result of examination performed wholeheartedly in order to solve the above-mentioned problems by the present inventors, it was found that the above-mentioned problems might be solved using a resin composition including polycaproamide resins (nylon 6) and poly(hexamethylene adipamide) resins (nylon 66) as a housing to give an excellent housing for fuse elements.

That is, summary of present invention is as follows.

(1) A polyamide resin composition for fuse elements, comprising;

a mixed polyamide of 100 parts by mass, including (A) polycaproamide (nylon 6) of 95 to 5% by mass and (B) poly(hexamethylene adipamide) (nylon 66) of 5 to 95% by mass; and

(C) a silicate layer of lamellar silicate of 0.1 to 20 parts by mass dispersed on molecular order level in the above described (A) and/or (B).

(2) The above described polyamide resin composition for fuse elements, wherein (D) an antioxidant of 0.1 to 4 parts by mass are further contained.

(3) The above described polyamide resin composition for fuse elements, wherein (E) metal soap based lubricant 0.01 to 0.5 parts by mass are further contained.

(4) The above described polyamide resin composition for fuse elements, wherein (F) inorganic fibrous reinforcing material 3 to 10 parts by mass are further contained.

(5) A fuse element comprising; a housing, a pair of terminals projecting from a predetermined flat surface thereof and aligned in a parallel state, and a fusing-element connected between base end sides of both terminals in the above described housing, wherein the above described housing is formed from the above described polyamide resin composition for fuse elements.

### BRIEF DESCRIPTION OF THE DRAWINGS

FIG. 1 is a vertical sectional view of a blade fuse for automobiles showing an embodiment of the present invention.

FIG. 2 is an A-A′ line sectional view in FIG. 1.

### EMBODIMENTS FOR CARRYING OUT THE INVENTION

Hereinafter, the present invention will be described in detail.

A resin composition for fuse elements of the present invention comprises; a mixed polyamide of 100 parts by mass containing (A) polycaproamide (nylon 6) of 95 to 5% by mass and (B) poly(hexamethylene adipamide) (nylon 66) of 5 to 95% by mass; and (C) a silicate layer of lamellar silicate of 0.1 to 20 parts by mass dispersed on molecular order level in the above described (A) and/or (B).

A mixed polyamide with (A) nylon 6 and (B) nylon 66 is required in order to maintain arc resistance required as a fuse element housing.

A mixing ratio of (A) polycaproamide (nylon 6) and (B) poly(hexamethylene adipamide) (nylon 66) in a resin composition of the present invention is dependent on a balance of transparency and heat resistance, and in the present invention, it is required to be in a range of(A)/(B)=5/95 to 95/5 (mass ratio), preferably in a range of 15/85 to 85/15. When polycaproamide exceeds 95% by mass, heat resistance of the molded housing deteriorates, being not preferable. On the other hand, in case of less than 5% by mass transparency deteriorates, being not also preferable.

Polycaproamide (nylon 6) in the present invention is a polymer having amide linkage in principal chain obtained by aminocaproic acid, ε-caprolactam, etc. as raw materials.

Poly(hexamethylene adipamide) (nylon 66) is a polymer having amide linkage in principal chain obtained by hexamethylenediamine and adipic acid (or salts thereof) as raw materials.

In polycaproamide or poly(hexamethylene adipamide), other monomers may be copolymerized in such a range as does not impair effectiveness of the present invention. As those monomers, examples of aminocarboxylic acid include ε-caprolactam, 12-aminododecanoic acid, 11-aminoundecanoic acid etc.; examples of lactams include ω-laurolactam, ω-undecanolactam etc.; examples of diamines include tetramethylenediamine, hexamethylenediamine, etc.; and examples of dicarboxylic acid include adipic acid, suberic acid, azelaic acid, sebacic acid, dodecandioic acid, terephthalic acid, isophthalic acid, 2-chloroterephthalic acid, 2-methylterephthalic acid, 5-methylisophthalic acid, 5-sodium sulphoisophthalic acid, hexahydroterephthalic acid, hexahydroisophthalic acid, etc. Diamine and dicarboxylic acid selected from the above described group may also be used as a pair of salt.

Although a molecular weight (relative viscosity) of a mixed polyamide resin used in the present invention is not especially limited, it is desirable that a relative viscosity measured under conditions that temperature of 25° C., concentration of 1 g/dL, sulfuric acid having a concentration of 96% by mass used as a solvent is in a range of 1.5 to 5.0, especially in a range of 2.0 to 4.0. When relative viscosity is less than 1.5, a tendency for the mechanical properties of molded article to be inferior is shown, and on the other hand when exceeding 5.0, a tendency for moldability to deteriorate remarkably is shown.

At least one of polycaproamide (nylon 6) or poly(hexamethylene adipamide) (nylon 66) in the present invention includes a silicate layer of lamellar silicate dispersed on molecular order level. A content is required to be 0.1 to 20 parts by mass, preferably 0.5 to 10 parts by mass, more preferably 0.8 to 5 parts by mass per 100 parts by mass of a mixed polyamide resin. Since the silicate layer has nanometer size as mentioned later and is minutely dispersed, it has a higher efficiency to reinforce resin matrix than other reinforcing materials. For this reason, in order to give rigidity equivalent to glass fiber reinforced resin, for example, small addition can demonstrate enough effectiveness. Therefore, when a composition of the present invention is applied to a thin molded material such as a fuse element housing, transparency becomes high. A size of the silicate layer itself also may help to demonstrate high transparency. Further, since the reinforcing material has considerably small size, a degree of abrasion of mold is substantially equivalent to that of polyamide resins not including reinforcing materials. In a large quantity of continuous production by injection molding, abrasion loss of mold may be significantly reduced compared with injection molding by other reinforcing materials, such as glass fiber productivity becomes also excellent.

When this amount of composition is less than 0.1 parts by mass, reinforcement effectiveness of resin matrix by a silicate layer of lamellar silicate is demonstrated poor, and rigidity and heat resistance may deteriorate when the polyamide resin composition is applied to fuse elements. When the amount of composition exceeds 20 parts by mass, it is not preferable that toughness deteriorates and transparency of polyamide resin composition deteriorates.

Lamellar silicate in the present invention has a structure formed of a crystal layer (silicate layer) having silicate as principal component and negatively charged, and ion-exchangable cations that intervenes between the layers. A silicate layer is a fundamental unit constituting a lamellar silicate, and is an inorganic crystal having a shape of a plate obtained by breaking down a layer structure of lamellar silicate (hereinafter referred to as “cleavage”). A silicate layer in the present invention represents one sheet of this layer, or a laminated state comprising not more than 5 layers by average of this layer. Dispersion in “molecule level” represents a state in which in case silicate layers of lamellar silicate are dispersed in a resin matrix, each of them exists with a distance between layers maintaining an average of no less than 2 nm, without formation of lumps. The distance between layers here represents a distance between center of gravity of the above described silicate layer. This state may be confirmed by observation of a photograph of a specimen of polyamide resin including the lamellar silicate by means of a transmission electron microscope.

A lamellar silicate is usable regardless of natural or artificial materials. Examples thereof include smectite groups (montmorillonite, beidellite, hectorite, sauconite, etc.); vermiculite groups (vermiculite etc.); mica groups (fluoromica, muscovite, palagonite, phlogopite, lepidolite, etc.); brittle mica groups (margarite, clintonite, anandite, etc.); chlorite groups (donbassite, sudoite, cookeite, clinochlore, chamosite, nimite, etc.). In the present invention, swellable fluoromica of Na type or Li type and montmorillonites are especially suitably used. Since swellable fluoromica is excellent in whiteness, it is especially preferable on appearance of resin composition obtained.

Swellable fluoromica has structural formula generally shown by a following formula, and is obtained by a melting or intercalation method.

Na_{α}(MgₓLi_{β}) Si₄O_{y}F_{z}

(where, 0≦α≦1, 0≦β≦0.5, 2.5≦x≦3, 10≦y≦11, 1.0≦z≦2.0)

Montmorillonite is represented by a following formula and obtained by refining natural products using an elutriation processing etc.

MₐSi₄ (Al₂₋ₐMg)O₁₀ (OH)₂.nH₂O

(where, M represents cations such as sodium, and 0.25≦a≦0.6. Since the number of water molecules combined with cation having ion exchange property between layers might be changed variously according to conditions, such as kind of cation and humidity, it is represented by nH₂O in the formula.)

In addition, existence of same type ion substituted products such as magnesian montmorillonite, iron montmorillonite and iron magnesian montmorillonite is known in montmorillonites, and these also may be usable.

In cation exchange capacity (CEC) determined by a method mentioned later, although lamellar silicate used in the present invention is not especially limited, it needs to be taken into consideration in following cases, and it is desirable that they are usually 40 to 200 milli-equivalent/10 g. Since swelling ability is low when this CEC is less than 40 milli-equivalent/100 g, sufficient cleavage is not attained when manufacturing a polyamide resin composition including silicate layer, resulting in that effective improvement is not achieved in rigidity or heat-resistance. On the other hand, when CEC exceeds 200 milli-equivalent/100 g, interaction between polyamide resin matrix and silicate layer becomes remarkably high, and it is not preferable that toughness of obtained polyamide resin composition significantly deteriorates and the resin becomes fragile.

In the present invention, as a case that should be taken into consideration, especially concerning CEC of lamellar silicate, a situation may be mentioned in which a crack formation based on shortage of strength in welded part existing in a housing part in a process of assembling a fuse element housing comprising a resin composition of the present invention into a fuse element. In order to avoid this phenomenon posing a problem in respect of productivity, it is preferable that lamellar silicate having a smaller CEC within the above described range of CEC of the lamellar silicate is used. In this case, it is effective to use lamellar silicate having CEC of, for example, 50 to 100 milli-equivalent/100 g, preferably of 50 to 70 milli-equivalent/100 g. Use of such a lamellar silicate does not give significant change to rigidity or heat resistance of the polyamide resin composition, but may be used satisfactorily as a fuse element housing.

In the present invention, there is especially no limitation about initial particle diameter of the above described lamellar silicate. Initial particle diameter here is a particle diameter of lamellar silicate as a raw material used when manufacturing a polyamide resin including lamellar silicate in the present invention, and it is different from a size of silicate layer in a composite material. However, this particle diameter affects mechanical properties of such a polyamide resin including lamellar silicate etc. not a little, and the particle diameter may also be controlled by pulverization using a jet mill etc. in order to control the physical properties. Further, when synthesizing swellable fluoromica based minerals by an intercalation method, the initial particle diameter may be varied by selecting appropriately a particle diameter of talc as a raw material. Since the initial particle diameter may be adjusted in a larger range by combined use with pulverization, this selection method is a preferable method.

Next, a method for manufacturing a polyamide resin composition for fuse elements of the present invention will be hereinafter described.

In polycaproamide (nylon 6) or poly(hexamethylene adipamide) (nylon 66) of the present invention, it is required that lamellar silicate is added and is cleaved to give a polyamide resin in which a silicate layer is dispersed on molecular order level. This may be enabled using a polyamide resin obtained by a method in which a predetermined amount of the above described monomer is polymerized in the presence of the above described lamellar silicate or by a method in which the lamellar silicate and the polyamide are melted and kneaded. Preferably a polyamide resin obtained by the former method is used. Monomer of polycaproamide (nylon 6) or poly(hexamethylene adipamide) (nylon 66) and a predetermined amount of lamellar silicate are introduced into an autoclave, and melting polymerization is performed within a range of a temperature of 240 to 300° C., a pressure of 0.2 to 3 MPa, and for 1 to 15 hours. As conditions for melting polymerization at that time, usual conditions for melting polymerization of nylon 6 and nylon 66 may be employable.

It is preferable to add acids when polyamide resin containing lamellar silicate is polymerized. Addition of acids will promote cleavage of the lamellar silicate and dispersion of the silicate layer in a resin matrix. Thereby a polyamide resin having a high rigidity and high heat resistance is obtained.

As long as an acid having has a pKₐ value (25° C., a value in water) of 0 to 6 or negative value, either organic acids or inorganic acids may be usable. Examples thereof include benzoic acid, sebacic acid, formic acid, acetic acid, chloroacetic acid, trichloroacetic acid, trifluoroacetic acid, nitrous acid, phosphoric acid, phosphorous acid, hydrochloric acid, hydrobromic acid, hydroiodic acid, nitric acid, sulfuric acid, perchloric acid, etc.

Addition amount of acid is preferably no more than 3 times in molar quantity to a total cation exchange capacity of the lamellar silicate, and more preferably 1 to 1.5 times in molar quantity. When this addition amount exceeds 3 times in molar quantity, it is not preferable that degree of polymerization of the polyamide resin becomes hard to increase, and productivity lowers.

Mixing of polycaproamide (nylon 6) with poly(hexamethylene adipamide) (nylon 66) may be performed by a pellet blending or a melt-kneading at a predetermined mixing ratio within the above described range. Only one selected from polycaproamides (nylon 6) and poly(hexamethylene adipamide)s (nylon 66) in which silicate layer is dispersed on molecular order level is used and may be blended with the other amide resin in which silicate layer is not dispersed. It goes without saying that both may be polyamide resins in which silicate layer is dispersed, and that these may be mixed.

A polyamide resin composition for fuse elements of the present invention preferably include 0.1 to 4 parts by mass of antioxidants per 100 parts by mass of mixed polyamide, and more preferably 0.3 to 3 parts by mass. Thereby an important characteristic of heat-resistant discoloration property as a fuse element may be provided. In case of less than 0.1 parts by mass, inhibition effect for discoloration is poor. When exceeding 4 parts by mass, effect corresponding to an amount of addition may not be demonstrated in many cases, and there is sometimes a tendency that raise of melt viscosity of the polyamide resin deteriorates moldability. Examples of preferable antioxidants include phenol based antioxidants exemplified by 2,6-di-ortho-butyl-4-methyl phenol, n-octadecyl-3-(3′,5′-di-t-butyl-4′-hydroxyphenyl) propionate, tetrakis[methylene-3-(3,5-di-t-butyl-4′-hydroxy phenyl) propionate]methane, tris(3,5-di-t-butyl-4′-hydroxy benzyl)isocyanurate, 4,4′-butylidenebis-(3-methyl-6-t-butyl phenol), triethylene glycol-bis-[3-(3-t-butyl-4-hydroxy-5-methyl phenyl)propionate], 3,9-bis {2-[3-(3-t-butyl-4-hydroxy-5-methyl phenyl) propionyloxy]-1,1-dimethyl ethyl}-2,4,8,10-tetraoxaspiro[5,5] undecane etc; sulfur based antioxidants exemplified by dilauryl-3,3′-thiodipropionate, dimyristyl-3,3′-thiodipropionate, distearyl-3,3′-thiodipropionate, pentaerythritol tetrakis(3-lauryl thiopropionate) etc.; and phosphorus based antioxidants etc. such as tris(nonylphenyl)phosphite (“ADKstab 1178”), tris(2,4-di-t-butylphenyl)phosphite (“ADKstab 2112”), bis(nonylphenyl)pentaerythritol diphosphite (“ADKstab PEP-4”), distearylpentaerythritol diphosphite (“ADKstab PEP-8”), bis (2,4-di-t-butylphenyl)pentaerythritol phosphite (“ADKstab PEP-24G”), bis(2,6-di-t-butyl-4-methylphenyl)pentaerythritol phosphite (“ADKstab PEP-36”), 2,2-methylenebis(4,6-di-t-butylphenyl)octyl phosphite (“ADKstab HP-10”), tetrakis(2,4-di-t-butylphenyl)-4,4′-biphenylene-di-phosphonite) etc. Especially preferable antioxidants are phosphorus based antioxidants. As examples of such compounds include ADKstab PEP-4, PEP-8, PEP-24G and PEP-36 etc. manufactured by ASAHI DENKA Co., Ltd. Among them, PEP-24G is most preferable to demonstrate excellent heat-resistant discoloration.

Metal soap based lubricants of 0.01 to 0.5 parts by mass, preferably 0.01 to 0.3 parts by mass per 100 parts by mass of mixed polyamide may be included in a polyamide resin composition for fuse elements of the present invention. When this content is less than 0.01 parts by mass, effect on mold-releasing characteristic is poor. When exceeding 0.5 parts by mass, influence of notable decrease in weld strength etc. may become remarkable. Examples of metal soap based lubricants include stearic acid based metal salts such as calcium stearate, magnesium stearate, aluminum stearate, zinc stearate, barium stearate, stannic stearate etc.; lauric acid metal salts such as calcium laurate, lauric acid, zinc laurate, etc.; ricinoleic acid based metal salts, such as, barium ricinolate, calcium ricinolate, zinc ricinolate, etc.; naphthenic acid based metal salts such as barium naphthenate and zinc naphthenate; montanic acid based metal salts such as sodium montanate, lithium montanate, calcium montanate, and zinc montanate, etc. A preferable example thereof is Montanic acid based metal salt. As examples of such compounds include Licomont NaV101, Licomont CaV102 and Licomont LiV103 grade manufactured by Clariant AG may be mentioned, and especially Licomont NaV101 provides preferable effect.

Inorganic fibrous reinforcing material may be further blended with a polyamide resin composition for fuse elements of the present invention, if needed, in a range of 3 to 10 parts by mass per 100 parts by mass of mixed polyamide. Amount of blend is adjusted to addition of silicate layer in a range that does not spoil transparency and abrasion-proof property of mold greatly. Examples of inorganic fibrous reinforcing material are glass fiber, Wallastonite, metal whisker, ceramic whisker, potassium titanate whisker, carbon fiber, etc. Glass fiber is most preferable.

In manufacturing a polyamide resin composition for fuse elements in the present invention, unless characteristics are spoiled greatly, dyestuff, pigment, coloring inhibitor, weathering agent, flame retarder, plasticizer, nucleus agent, mold lubricant, etc. maybe added other than thermostabilizers, antioxidant, and reinforcing material. These may just be added, if needed, at the time of manufacture of either one of polyamides, and of mixing of both polyamides.

Examples of other reinforcing materials include, for example, clay, talc, calcium carbonate, zinc carbonate, silica, alumina, magnesium oxide, calcium silicate, sodium aluminate, sodium aluminosilicate, magnesium silicate, glass balloon, carbon black, zeolite, hydrotalcite, boron nitride, graphite, etc.

A polyamide resin composition for fuse elements of the present invention has excellent arc resistance and anti-heat deformation property, transparency, and abrasion-proof property of mold. Such a resin composition may be easily molded into a housing for fuse elements by conventional molding methods, such as injection molding.

### EXAMPLES

The present invention will be described with reference to Examples still more in detail. The present invention is, however, not limited only by these Examples. In addition, measurement of raw material and various physical properties values used in Reference Examples, Examples and Comparative Examples are shown below.

1. Raw Materials

(1) Swellable Fluoromica

“Somasif ME 100” by Co-op Chemical Co., Ltd was used. According to CEC measurement mentioned later, this CEC was 100 milli-equivalent/100 g.

(2) Montmorillonite

“Kunipia-F” manufactured by Kunimine Co., Ltd. was used. According to CEC measurement mentioned later, this CEC was 110 milli-equivalent/100 g.

(3) Nylon 6 (P-3)

As nylon 6 that does not include silicate layer, “As1030BRL” manufactured by UNITIKA LTD. was used.

(4) Nylon 66 (P-5)

As nylon 66 that does not include silicate layer, “A125” manufactured by UNITIKA LTD. was used.

(5) Heat-Resistant Modifier (Phosphorous Acid Ester Based Compound)

“PEP-24G” manufactured by ASAHI DENKA Co. Ltd. was used.

(6) Mold-Releasing Modifier (Metal Soap Based Lubricant)

“Licomont NaV101” manufactured by Clariant AG was used.

(7) Glass Fiber (Inorganic Fibrous Reinforcing Material)

“T289” manufactured by Nippon Electric Glass Co., Ltd. was used.

2. Measuring Method

(1) Relative Viscosity of Polyamide Resin

In 96% by mass concentrated sulfuric acid, dry pellet of polyamide resin was dissolved so that a concentration of 1 g/dL might be obtained, and measurement was carried out at 25° C. When silicate layer is included in the polyamide resin, dry pellet was measured based on a value of inorganic ash content so that concentration of polyamide component of 1 g/dL might be obtained. The pellet was dissolved, and subsequently inorganic component was filtered out by G-3 glass filter, and measurement was carried out.

(2) Content of Inorganic Ash Contents of Silicate Layer Dispersed Polyamide

Pellet of dry polyamide resin was precisely weighed into a porcelain crucible, residue after incinerated for 15 hours in an electric furnace maintained at 500° C. was obtained as an inorganic ash. Ash content was calculated according to following formula.

Inorganic ash content (% by mass)=[inorganic ash content mass (g)]/[all mass of specimen before incineration processing (g)]×100)

(3) Cation Exchange Capacity

A value thereof was obtained based on cation exchange capacity measuring method (JABS-106-77) of bentonite (powder) by Japan Bentonite Manufacturers Association Standard.

That is, using an equipment with which decoction container, exudation tubing, and receiver were connected lengthwise, firstly all of ion exchangeable cations between layers of lamellar silicate were exchanged to NH₄⁺ by 1N ammonium acetate aqueous solution adjusted to pH=7. Subsequently, after fully cleaning with water and ethyl alcohol, the above mentioned NH₄⁺ type lamellar silicate was dipped into 10% by weight of potassium chloride aqueous solution, and NH₄⁺ in specimen was exchanged to K⁺. Then, leached-out NH₄⁺ in connection with the above described ion exchange reaction was titrated for neutralization with 0.1N sodium hydroxide aqueous solution. Thereby cation exchange capacity (milli-equivalent/100 g) of swellable lamellar silicate, that is raw material, was determined.

(4) Dispersing State of Silicate Layer

Sample cut in small from a specimen for a method of bending modulus measurement, mentioned later, was embedded into epoxy resin, an ultrathin section was cut out using a diamond knife. Photograph was taken of this specimen using a transmission electron microscope (manufactured by Japan Electron Optics Laboratory Co., Ltd., JEM-200CX type, accelerating voltage 100 kv). In silicate layer of swellable lamellar silicate displayed in this electron microscope photograph, an approximate size and distance between layers were obtained, and thus dispersibility of silicate layer was evaluated.

(5) Arc-Resistance of Polyamide Resin Composition

Measured based on ASTM D-495.

(6) Bending Modulus of Specimen

Measured based on ASTM D-790.

(7) Load Deflection Temperature of Specimen

Measured based on ASTM D-648 by load of 0.45 MPa.

(8) Transparency

Injection molding of a plate of 50 mm×90 mm×1 mm was carried out using IS-100E injection molding machine (manufactured by TOSHIBA MACHINE CO., LTD.) with a set value of barrel temperature of 280° C., and mold temperature of 40° C. This plate was placed on a cardboard with characters written thereon, and it was evaluated whether the characters on the cardboard might be readable.

∘: readable

x: not readable

(9) Heat Sag (Amount of Hang-Down)

Injection molding of a specimen of 120 mm×12.7 mm×0.8 mm was carried out using IS-100E injection molding machine (manufactured by TOSHIBA MACHINE CO., LTD.) with a set value of barrel temperature of 280° C., and mold temperature of 40° C. Molded body edge of 20 mm of obtained specimen was cantilevered in longitudinal direction with a clamp and subjected heat-treating for 20 seconds in 290° C. oven. An amount of hang down was measured. The larger this value is, the lower the form retention property.

(10) Heat Discoloration Property

Injection molding of a specimen of 50 mm×90 mm×1 mm was carried out using IS-100E injection molding machine (manufactured by TOSHIBA MACHINE CO., LTD.) with a set value of barrel temperature of 280° C., and mold temperature of 40° C. This plate was heat-treated in 125° C. oven for 1000 hours, and color change ΔE before and after heat treatment was measured using SZ-Σ90 type color difference meter manufactured by Nipponn Denshoku Industries Co., Ltd. The smaller this value is, the smaller the degree of discoloration is.

(11) Mold-Releasing Characteristic

Using CND15 A-II injection molding machine manufactured by Niigata Iron Works, 100000-shot injection molding of a piece of molding of 10 mm×10 mm×1 mm was carried out with a set value of barrel temperature of 280° C., and mold temperature of 30° C. Percentage (%) of inferior goods in mold release occupied to the total number of shots was calculated and evaluated. The smaller this value is, the more excellent mold-releasing characteristic is and the higher the productivity is.

(12) Mold Abrasion Property

Using CND15 A-II injection molding machine manufactured by Niigata Iron Works, 100000-shot injection molding of a piece was carried out with a set value of barrel temperature of 280° C., and mold temperature of 30° C., where a mold made of PX5 steel materials (Daido Steel Co., Ltd.) was used to provide a piece of molding of 10 mm×10 mm×1 mm having a side gate with width of 2.0 mm, a height of 0.5 mm and a length of 3.0 mm. A height of the gate part of molded piece was measured at the time. The height was compared with that at a start of molding, and percentage of increase (%) in height was evaluated. The smaller the value is, the smaller the amount of abrasion is.

### Reference Example 1

Manufacture of Silicate Layer—Dispersed Polyamide (P-1)

ε-caprolactam 1.0 kg and swellable fluoromica 400 g (total amount of CEC equivalent to 0.4 mole) were mixed into water 1 kg, and were agitated for 1 hour using homogeneous mixer. Then, the resultant mixed solution and 46.2 g (0.4 mole) of 85% by mass phosphoric acid aqueous solution were introduced into an autoclave with 30 liters of capacity containing ε-caprolactam 9.0 kg beforehand. Temperature of the mixed solution was raised to 120° C. with agitation. Then the temperature was maintained for 1 hour while agitation was continued. The mixed solution was heated up to 260° C. and pressure was raised to 1.5 MPa. Temperature was maintained at 260° C., and pressure was maintained at 1.5 MPa for 2 hours, while emitting steam gradually. Pressure was decreased to atmospheric pressure in 1 hour. Polymerization was further continued for 40 minutes.

When polymerization was completed, the resultant was taken out in a shape of strands, and was cut after cooling and solidification. This was refined to obtain nylon 6 (P-1) including silicate layer.

When transmission electron microscope observation was performed about pellets P-1 after refined and dried, it was confirmed that swellable fluoromica-based mineral was cleaved, and silicate layer was dispersed on molecular order level in a resin matrix. In addition, a content of silicate layer in P-1 by ash content measurement gave 4.5% by mass.

### Reference Example 2

Manufacture of Silicate Layer—Dispersed Polyamide (P-2)

Nylon 6 (P-2) including silicate layer was obtained as in Reference Example 1, except for having used montmorillonite instead of swellable fluoromica, and having used 85% by mass phosphoric acid aqueous solution (50.8 g) equivalent to total amount of CEC of montmorillonite (0.44 mole).

When transmission electron microscope observation was performed about pellets P-2 after refined and dried, it was confirmed that montmorillonite was cleaved, and silicate layer was dispersed on molecular order level in a resin matrix. In addition, a content of silicate layer in P-2 by ash content measurement gave 4.5% by mass.

### Reference Example 3

Manufacture of Silicate Layer—Dispersed Polyamide (P-4)

Swellable fluoromica 400 g was mixed with water 1 kg under room temperature. The mixture was agitated for 2 hours using homogeneous mixer to give water dispersion of swellable fluoromica.

On the other hand, nylon 66 salt 10 kg (produced by BASF AG “AH salt”) and water 2 Kg were introduced into an autoclave with 30 liters of capacity. Temperature was raised to 280° C., and pressure was raised to 1.8 MPa, while being agitated. Temperature was maintained at 280° C. and pressure was maintained at 1.8 MPa for 2 hours, while emitting steam gradually. Pressure was decreased to 1.0 MPa in 1 more hour. At this time, whole quantity of the water dispersion of swellable fluoromica based mineral prepared previously was introduced, and conditions of 280° C. and 1.0 MPa were maintained for 1 hour. Then, pressure was decreased to atmospheric pressure in 1 hour. Polymerization was further performed under atmospheric pressure for 1 hour.

When polymerization was completed, the resultant was taken out in a shape of strands, and was cut after cooling and solidification to give nylon 66 (P-4) including silicate layer.

When transmission electron microscope observation was performed about pellets P-4 after dried, it was confirmed that swellable fluoromica based mineral was cleaved, and silicate layer was dispersed on molecular order level in a resin matrix. In addition, a content of silicate layer in P-4 by ash content measurement gave 4.1% by mass.

### Examples 1 to 14

Polyamide resin compositions having compositions of Examples 1 to 14 shown in Table 1 were obtained by melt-kneading using TEM-37BS type biaxial extruder manufactured by TOSHIBA MACHINE CO., LTD. Each resin of P-1 to P-5 was blended with compounding ratio indicated in the table, and cylinder temperature was set at 270 to 290° C., screw speed at 200 rpm, and extrusion amount at 150 kg/hr. Strands immediately after extrusion was water-cooled, pelletized in pelletizer. The obtained pellets was provided to injection molding after dried.

TABLE 1

| | | | | Examples | | | | | | | | | | | | | |
|---|---|---|---|---|---|---|---|---|---|---|---|---|---|---|---|---|---|
| | | | | 1 | 2 | 3 | 4 | 5 | 6 | 7 | 8 | 9 | 10 | 11 | 12 | 13 | 14 |
| Housing | Mixing ra- | Resin having | P-1* | 40.7 | 40.7 | 22.2 | 40.7 | 40.7 | 40.7 | 40.7 | 40.7 | 83 | 40 | 20.2 | 40.7 | — | — |
| compo- | tio of | nylon 6 as princi- | P-2* | — | — | — | — | — | — | — | — | — | — | — | — | 40.7 | — |
| sition | polyamide | pal component | P-3 | — | — | 17.8 | — | — | — | — | — | — | 39 | — | — | — | 41 |
| | raw mater- | Resin having | P-4* | — | — | — | — | — | — | — | — | — | — | — | — | — | 61.6 |
| | ial (part | nylon 66 as prin- | P-5 | 61.1 | 61.1 | 61.1 | 61.1 | 61.1 | 61.1 | 61.1 | 61.1 | 21 | 21 | 80.7 | 61.1 | 61.1 | — |
| | by mass) | cipal component | | | | | | | | | | | | | | | |
| | Amount of each component in | | (A)/ | 39/61 | 39/61 | 39/61 | 39/61 | 39/61 | 39/61 | 39/61 | 39/61 | 79/21 | 79/21 | 19/81 | 39/61 | 39/61 | 41/59 |
| | the above-mentioned mixture | | (B) | | | | | | | | | | | | | | |
| | (part by mass) | | (C) | 1.8 | 1.8 | 1.0 | 1.8 | 1.8 | 1.8 | 1.8 | 1.8 | 3.7 | 1.8 | 0.9 | 1.8 | 1.8 | 2.6 |
| | Other | Ester of | (part | — | 0.1 | 0.1 | 0.3 | 0.1 | 2.0 | 1.0A | 1.0- | 1.0 | 1.0 | 1.0 | 1.0 | 1.0 | 1.0 |
| | additives | phosphorous acid | by | | | | | | | | HA | | | | | | |
| | | | mass) | | | | | | | | | | | | | | |
| | | Metal soap based | (part | — | 0.2 | 0.2 | 0.2 | 0.2 | 0.2 | 0.2 | 0.2 | 0.2 | 0.2 | 0.2 | 0.2 | 0.2 | 0.2 |
| | | lubricant | by | | | | | | | | | | | | | | |
| | | | mass) | | | | | | | | | | | | | | |
| | | Inorganic fibrous | (part | — | — | — | — | — | — | — | — | — | — | — | 4.0 | — | — |
| | | reinforcing mater- | by | | | | | | | | | | | | | | |
| | | ial | mass) | | | | | | | | | | | | | | |

| | | | | | | | | | | | | | | | | |
|---|---|---|---|---|---|---|---|---|---|---|---|---|---|---|---|---|
| Physical | Arc-resistance | (sec) | 140 | 140 | 140 | 140 | 140 | 140 | 140 | 140 | 138 | 138 | 148 | 148 | 140 | 148 |
| proper- | Bending Modulus | (MPa) | 4.0 | 4.0 | 3.8 | 4.0 | 4.0 | 4.0 | 4.0 | 4.0 | 4.2 | 3.8 | 3.8 | 4.3 | 4.1 | 4.8 |
| ties | Load deflection temperature | (° C.) | 200 | 200 | 190 | 200 | 200 | 200 | 200 | 200 | 200 | 190 | 215 | 230 | 200 | 240 |
| | transparency | | ◯ | ◯ | ◯ | ◯ | ◯ | ◯ | ◯ | ◯ | ◯ | ◯ | ◯ | ◯ | ◯ | ◯ |
| | Heat sag (amount of hang- | (mm) | 10 | 10 | 12 | 10 | 10 | 10 | 10 | 10 | 10 | 12 | 8 | 2 | 10 | 6 |
| | down) | | | | | | | | | | | | | | | |
| | Heat discoloration property | | >40 | 20 | 20 | 12 | 8 | 6 | >40 | >40 | 9 | 9 | 10 | 9 | 12 | 10 |
| | (ΔE) | | | | | | | | | | | | | | | |
| | Mold-releasing characteristic | (%) | <1.5 | <0.5 | <0.5 | <0.5 | <0.5 | <0.5 | <0.5 | <0.5 | <0.5 | <0.5 | <0.5 | <0.5 | <0.5 | <0.5 |
| | Mold abrasion property (per- | (%) | 0.3 | 0.3 | 0.3 | 0.3 | 0.2 | 0.3 | 0.2 | 0.2 | 0.2 | 0.2 | 0.3 | 1.0 | 0.3 | 0.2 |
| | centage of height increase) | | | | | | | | | | | | | | | |

Notes:
“*” shows silicate layer-dispersed polyamide.
“(A)” represents nylon 6 component, (B) represents nylon 66 component, and (C) represents silicate layer component, repectively.
In column of Ester of phosphorous acid in Example 7 and 8, “A” represents amine based antioxidant (Nowguard 455 manufactured by Shiraishi Calcium Co.), “HP” represents hindered phenol compound (IRGANOX 1098 manufactured by Chiba Specialty Chemicals). Each of them was used 1.0 part by mass instead of ester of phosphorous acid.

### Comparative Examples 1 to 9

Comparative Examples 1 to 5 shown in Table 2 are test results independently carried out for each of P-1 to P-5. Polyamide resin compositions having compositions in Comparative Examples 6 to 9 were obtained by melt-kneading using TEM-37BS type biaxial extruder manufactured by TOSHIBA MACHINE CO., LTD. Each resin was blended with each compounding ratio, and cylinder temperature was set at 270 to 290° C., screw speed at 200 rpm, and extrusion amount at 150 kg/hr. Strands immediately after extrusion was water-cooled, pelletized in pelletizer. The obtained pellets was provided to injection molding after dried.

TABLE 2

| | | | | Comparative Examples | | | | | | | | | Conventional |
|---|---|---|---|---|---|---|---|---|---|---|---|---|---|
| | | | | 1 | 2 | 3 | 4 | 5 | 6 | 7 | 8 | 9 | Example |
| Housing | Mixing ratio of | Resin having | P-1* | 104.7 | — | — | — | — | — | — | — | — | — |
| composition | polyamide raw mat- | nylon 6 as | P-2* | | 104.7 | — | — | — | — | — | — | — | — |
| | erial (part by mass) | principal com- | P-3 | — | — | 100 | — | — | 100 | — | 40 | 40 | — |
| | | ponent | | | | | | | | | | | |
| | | Resin having | P-4* | — | — | — | 104.3 | — | — | — | — | — | — |
| | | nylon 66 as | P-5 | — | — | — | — | 100 | — | 100 | 60 | 60 | — |
| | | principal com- | | | | | | | | | | | |
| | | ponent | | | | | | | | | | | |

| Amount of each component in the | | (A)/(B) | 100/0 | 100/0 | 100/0 | 100/0 | 0/100 | 100/0 | 0/100 | 40/60 | 40/60 | — |
|---|---|---|---|---|---|---|---|---|---|---|---|---|
| above-mentioned mixture (part by | | (C) | 4.7 | 4.7 | 0 | 4.3 | 0 | 0 | 0 | 0 | 0 | — |
| mass) | | | | | | | | | | | | |
| Polyethersulfone | | (% by mass) | — | — | — | — | — | — | — | — | — | 100 |
| Other | Ester of phosphorous acid | (part by mass) | — | — | — | — | — | — | — | — | — | — |
| addi- | Metal soap based lubricant | (part by mass) | — | — | — | — | — | — | — | — | — | — |
| tives | Inorganic fibrous reinforc- | (part by mass) | — | — | — | — | — | 42.9 | 42.9 | — | 10 | — |
| | ing material | | | | | | | | | | | |

| | | | | | | | | | | | | |
|---|---|---|---|---|---|---|---|---|---|---|---|---|
| Physical | Arc-resistance | (sec) | 145 | 143 | 146 | 148 | 148 | 147 | 150 | 148 | 148 | 100 |
| properties | Bending Modulus | (MPa) | 4.5 | 4.4 | 2.6 | 4.7 | 2.9 | 7.8 | 8.1 | 3.9 | 5.6 | 2.6 |
| | Load deflection temperature | (° C.) | 195 | 195 | 174 | 242 | 235 | 215 | 260 | 225 | 245 | 210 |
| | transparency | | X | X | X | X | X | X | X | ◯ | ◯ | ◯ |
| | Heat sag (amount of hang down) | (mm) | >30 | >30 | >40 | 8 | 10 | 7 | 2 | >30 | 2 | 4 |
| | Heat discoloration property (ΔE) | | >40 | >40 | >40 | >40 | >40 | >40 | >40 | >40 | >40 | 8 |
| | Mold-releasing characteristic | (%) | <1 | <1 | <2 | <1 | <2 | <0.5 | <0.5 | <0.5 | <0.5 | <0.5 |
| | Mold abrasion property (percentage | (%) | 0.3 | 0.3 | 0.3 | 0.3 | 0.3 | 3.8 | 3.2 | 0.3 | 2.2 | — |
| | of height increase) | | | | | | | | | | | |

Notes:
“*” represents silicate layer dispersed polyamide.
“(A)” represents nylon 6 component, (B) represents nylon 66 component, and (C) represents silicate layer component, respectively.

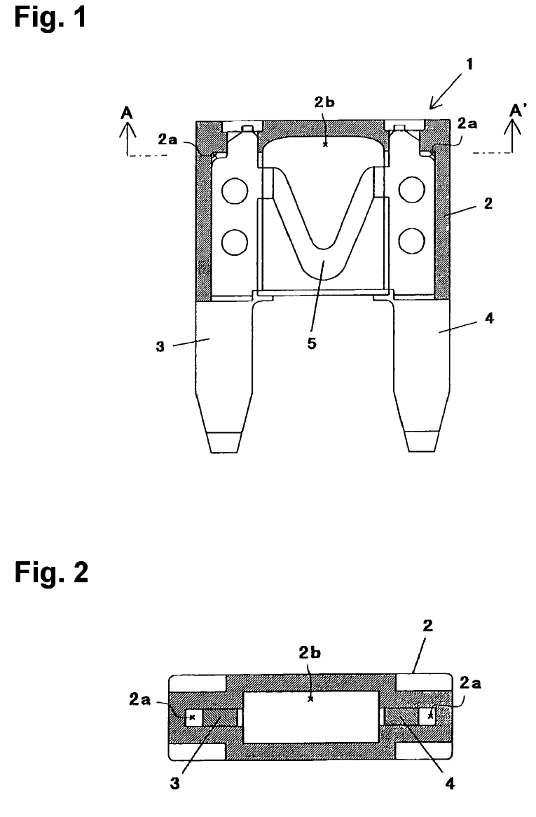

Polyamide resin compositions obtained in Examples 1 to 14 gave preferable results in evaluations of arc resistance, amount of hang-down in heat sag examination, transparency, and mold abrasion property. It became clear that polyamide resin compositions are suitably usable for fuse element for electric circuit for automobiles, for example, as represented in FIG. 1.

In Examples 2 to 14, since phosphorous acid ester compound was added, results of further improved heat-resistant discoloration property was obtained, and Examples 5 and 6 gave especially outstanding heat-resistant discoloration property. In every comparative example, there were problems on heat-resistant discoloration property. Especially as shown in comparative Examples 1 to 7 the case in which only one of polyamide components was used was not satisfactory with respect to transparency and mold-releasing characteristic. Problem was shown in form retention property by heat sag examination in Comparative Examples 1 and 2. Amount of mold abrasion loss was large in Comparative Examples 6 and 7. There were problems in form retention property in Comparative Example 8, and in mold abrasion property in Comparative Example 9, respectively.

### INDUSTRIAL APPLICABILITY

According to the present invention, a polyamide resin composition assures sufficient arc resistance upon boosting of vehicles voltage (42 V system), being excellent in rigidity, heat resistance and transparency. The polyamide resin composition of the present invention may be suitably used as fuse elements in electric circuits for automobiles etc.

1. A polyamide resin composition for fuse elements, comprising:
100 parts by mass of a mixed polyamide consisting of (A) 95 to 5% by mass of polycaproamide (nylon 6) and (B) 5 to 95% by mass of poly(hexamethylene adipamide) (nylon 66); and
(C) 0.1 to 20 parts by mass of a silicate layer of lamellar silicate dispersed on molecular order level in said (A) and/or said (B).

2. The polyamide resin composition for fuse elements according to claim 1, further comprising;
(D) 0.1 to 4 parts by mass of an antioxidant to 100 parts by mass of said mixed polyamide.

3. The polyamide resin composition for fuse elements according to claim 1 or 2, further comprising;
(E) 0.01 to 0.5 parts by mass of a metal soap based lubricant to 100 parts by mass of said mixed polyamide.

4. The polyamide resin composition for fuse elements according to one of claims 1 to 3, further comprising;
(F) 3 to 10 parts by mass of an inorganic fibrous reinforcing material to 100 parts by mass of said mixed polyamide.

5. A fuse element comprising; a housing, a pair of terminals projecting from a predetermined flat surface thereof and aligned in a parallel state, and a fusing element connected between base end sides of both terminals in said housing, wherein said housing is formed from the polyamide resin composition for fuse elements according to one of claims 1 to 4.
